(19) United States
(12) Patent Application Publication
(10) Pub. No.: US 2011/0113674 A1
(43) Pub. Date: May 19, 2011

(54) Inhibiting Pest Infestation

(75) Inventor: David H. Levy, Berkekey, CA (US)

(73) Assignee: TH, Inc.

(21) Appl. No.: 12/907,326

(22) Filed: Oct. 19, 2010

Related U.S. Application Data
(60) Provisional application No. 61/255,641, filed on Oct. 28, 2009.

(51) Int. Cl. A01M 13/00; A01M 1/00; A01M 1/20

(52) U.S. Cl. 43/125; 43/124; 43/132.1

(57) ABSTRACT

A method for inhibiting pest infestation. The method includes introducing a pest-killing material into an interior compartment of a closed piece of luggage, thereby exterminating pests residing within the interior compartment.

### CROSS-REFERENCE TO RELATED APPLICATIONS

This application claims benefit from U.S. Provisional Patent Application 61/255,641, filed Oct. 28, 2009, the entire disclosure of which is incorporated herein by reference.

### TECHNICAL FIELD

This disclosure relates to inhibiting pest infestation, and, in particular, to inhibiting the introduction of pests into a dwelling via personal luggage.

### BACKGROUND

Pests, such as bed bugs (Cimex lectularius), lice, tics, and fleas, can be transported from a travel destination and unwittingly introduced into home via infested luggage. Eradicating these pests, especially bed bugs, can be extremely difficult, and can result in an on-going battle that can be physically, mentally, and financially taxing. Once limited mainly to third world locations, the bed bug problem has spread such that any country, indeed any hotel, may be a potential source of infestation. The problem has grown to sufficient size that the US Environmental Protection Agency (EPA) held a two day national Bed Bug Summit in Washington, D.C. in April of 2009.

### SUMMARY

In general, this invention relates to inhibiting pest infestation, and, in particular, to inhibiting the introduction of pests into a dwelling via personal luggage.

One aspect of the invention features a method for inhibiting pest infestation. The method includes introducing a pest-killing material into an interior compartment of a closed piece of luggage, thereby exterminating pests residing within the interior compartment.

Embodiments may include one or more of the following features.

In some embodiments, the pest-killing material is a gas. The gas can be an insecticide, such as sulfuryl fluoride or Pyrethrin, a natural insecticide, derived from the Chrysanthemum flower. The gas can also be carbon dioxide.

The method can include heating or cooling the pest-killing material. Introducing the pest-killing material into the interior compartment of the closed piece of luggage can include introducing the heated or cooled pest-killing material into the interior compartment of the closed piece of luggage.

In certain embodiments, introducing the pest-killing material into the interior compartment of the closed piece of luggage can include delivering the pest-killing material from a canister into the interior compartment of the closed piece of luggage.

In some embodiments, introducing the pest-killing material into the interior compartment of the closed piece of luggage can include delivering the pest-killing material into the interior compartment of the closed piece of luggage via a hose.

In certain embodiments, introducing the pest-killing material into the interior compartment of the closed piece of luggage includes delivering the material through an inlet port in the luggage.

In some embodiments, the inlet port can include an elastomeric gasket.

The method can also include monitoring a temperature within the interior compartment of the closed piece of luggage.

The method can also include utilizing one or more thermistors disposed within the interior compartment to monitor the temperature within the interior compartment.

The method can also include calculating a waiting period. The waiting period corresponds to a period of time to wait, to allow the pest-killing material to kill pests residing within the interior compartment, before opening the piece of luggage. For example, bedbugs can be killed in all life stages at 140° F.-150° F. for an hour or 120° F. for 24 hours.

In some embodiments, the waiting period is calculated based on a set of known parameters relating to at least one target pest.

The method can also include, utilizing a microprocessor to calculate the waiting period.

The method can also include waiting a predetermined period of time, to allow the pest-killing material to kill pests residing within the interior compartment, before opening the closed piece of luggage. The predetermined period of time can be calculated based on a set of known parameters relating to at least one target pest.

In certain embodiments, the pests include bed bugs.

In some embodiments, the interior compartment has a volume of less than 6 cubic feet (e.g., about 2 cubic feet to about 4 cubic feet, e.g., about 3 cubic feet).

In certain embodiments, the method includes traveling from a first location (e.g., home) to a second location (e.g., travel destination) with the luggage and without the pest-killing material.

The method can also include storing the pest-killing material at the first location while traveling from the first location to the second location.

The step of introducing the pest-killing material into the substantially air tight interior compartment of the closed piece of luggage is performed after returning to the first location from the second location.

In some embodiments, the interior compartment is substantially airtight.

The pest-killing material can be heated air, and introducing the pest killing material can include activating a heating element. For example, in some cases, introducing the pest-killing material includes activating a heating element to heat air residing within the interior compartment of the closed piece of luggage.

The air can be heated to a temperature of about 120° F. to about 150° F. over a time period of at least one hour. For example, in some cases, the air is heated to a temperature of about 140° F. to about 150° F. over a time period of at least one hour. In some cases, the air is heated to a temperature of about 120° F. over a time period of at least 24 hours.

Another aspect of the invention provides a system for inhibiting pest infestation. The system includes a personal effects transporting case that is closable to provide a interior compartment for storing personal effects. The system also includes an input port that is arranged to accommodate the introduction of a pest-killing material into the interior compartment.

Embodiments may include one or more of the following features.

In some embodiments, the input port is arranged between an outer surface of the personal effects transporting case and the interior compartment.

In certain embodiments, the inlet port includes an elastomeric gasket.

In some embodiments, the interior compartment is capable of retaining gas or vapor.

In certain embodiments, the system can also include a delivery device containing a pest-killing material. The delivery device can include an outlet capable of cooperating with the input port for introducing the pest-killing material into the interior compartment.

In some embodiments, the pest-killing material is a gas. The gas can be an insecticide, e.g., sulfuryl fluoride, Pyrethrin (a natural insecticide derived from the Chrysanthemum flower), or carbon dioxide.

In certain embodiments, the system can include a temperature measurement device arranged to measure a temperature within the interior compartment.

In some embodiments, the system can include a display device configured to display a temperature measured by the temperature measurement device.

In certain embodiments, the personal effects transporting case includes a microprocessor configured to calculate a waiting period. The waiting period corresponds to a period of time to wait, to allow the pest-killing material to kill pests residing within the interior compartment, before opening the personal effects transporting case.

In some embodiments, the microprocessor is configured to calculate the waiting period based on a set of known parameters relating to at least one target pest.

In certain embodiments, the interior compartment has a volume of less than 6 cubic feet (e.g., about 2 cubic feet to about 4 cubic feet, e.g., about 3 cubic feet).

Embodiments can include one or more of the following advantages.

In some embodiments, the systems and/or methods can inhibit (e.g., prevent) travelers from infesting their homes by means of insect hitchhikers hidden within luggage.

In certain embodiments, the systems and/or methods can be used to eradicate pests that may be located in personal luggage and to do so while limiting the risk of accidental infestation during the act of eradication. As a result, travel anxiety associated with the accidental infestation of a home via personal luggage can be reduced.

In some embodiments, the systems and/or offer prophylactic pest control without requiring a traveler to carry pest-killing materials, which may contain toxins, on a trip. Also, leaving the pest-killing material at a final destination (e.g., the travelers home) avoids the added weight and reduced volume associated with carrying a prophylactic pest control means within luggage during a trip.

The interior compartment can be substantially air tight.

According to yet another aspect, a system is provided for inhibiting pest infestation. The system includes a personal effects transporting case that is closable to provide a interior compartment for storing personal effects. The system also includes a heating element.

Embodiments may include one or more of the following features.

The heating element can be ribbon wire such as kanthol (FeCrAl), nichrome or cupronickel (CuNi). Thermal coefficient of resistance ceramics (such as barium titanate and lead titanate) can act as its own thermistor.

In some embodiments, the heating element is integrally manufactured within the person effects transporting case.

In some cases, the heating element is adapted to reside within the interior compartment and is removable from the personal effects transporting case.

The system can include one or more thermistors, disposed within the interior compartment, to monitor the temperature within the interior compartment.

The interior compartment can be substantially air tight.

In yet another aspect, a method for inhibiting pest infestation includes heating air in an interior compartment of a closed piece of luggage, thereby exterminating pests residing within the interior compartment.

Embodiments may include one or more of the following features. The air can be heated to a temperature of about 120° F. to about 150° F. over a time period of at least one hour. For example, in some cases, the air is heated to a temperature of about 140° F. to about 150° F. over a time period of at least one hour. In some cases, the air is heated to a temperature of about 120° F. over a time period of at least 24 hours.

Other aspects, features, and advantages are in the description, drawings, and claims.

### DESCRIPTION OF DRAWINGS

FIG. 1 shows a suitcase with a port for introducing pest-killing material.

FIG. 2 shows a pressurized gas container inserted into a suitcase.

FIG. 3 shows a pest-killing material delivery device interlocking with a suitcase.

FIG. 4 shows a suitcase with two ports for introducing pest-killing material.

Like reference symbols in the various drawings indicate like elements.

### DETAILED DESCRIPTION

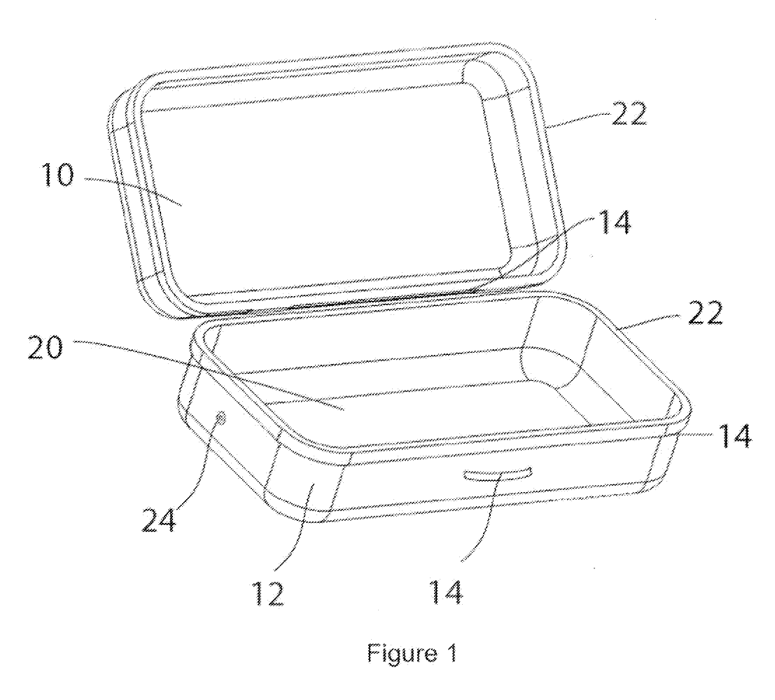

FIG. 1 shows a personal effects transporting case (e.g., luggage), here a suitcase 10 which includes an exterior surface 12 sufficiently non-porous to inhibit (e.g., prevent) pests, such as bed bugs, to adhere to it during the various stage of the pest's life cycle. External structures 14, such as hinges, straps, joints, seams and the like, can be designed to provide smooth surfaces and/or gaps sufficiently large and exposed so as not to provide a hiding place for pests.

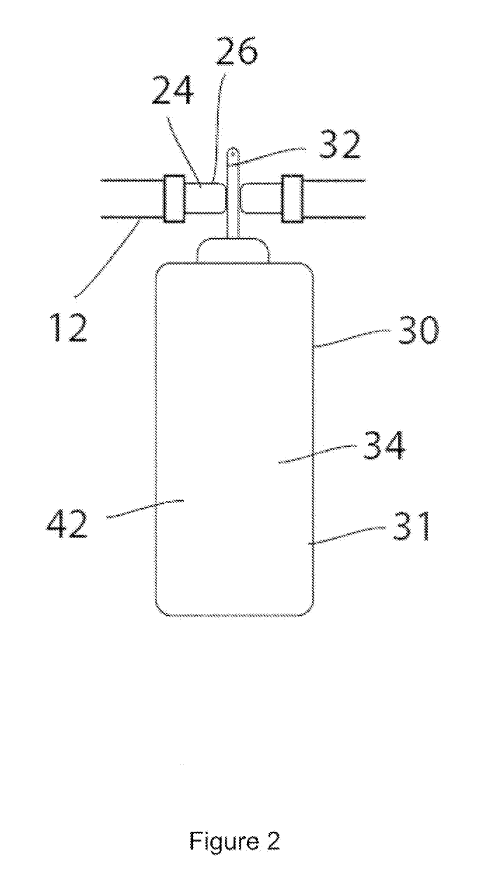

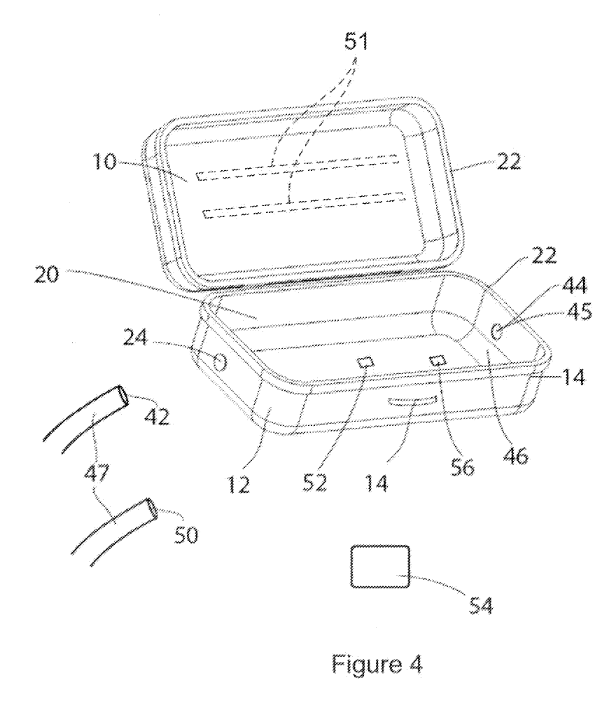

A possible hiding place for pests is an interior compartment 20 of the suitcase 10, which can have a volume of less than six cubic feet (e.g., about 2 cubic fee to about 4 cubic feet, e.g., about 3 cubic feet). To address this, the suitcase 10 includes a gasket 22 disposed around an edge at which two halves of the suitcase 10 contact each other, as well as other incidental openings, such that the suitcase 10 is well-sealed or effectively airtight (i.e., hermetically sealed) when closed. The suitcase 10 is also provided with an inlet port 24 that is designed to accommodate the introduction of a pest-killing material into the interior compartment 20. A delivery device 30 (such as a canister 31 (FIG. 2) and/or hose 47 (FIG. 4)) with an injector outlet 32, designed to connect to inlet port 24, can also be provided to facilitate the injection of a pest-killing material, such as an insecticide 34 (e.g., sulfuryl fluoride, Pyrethrin, etc.) or a lethal non-insecticide gas (e.g., carbon dioxide), into the interior compartment 20.

In operation: when the user returns from a trip and before opening her suitcase 10 for the first time at home, the user can introduce a pest-killing material into the interior compartment 20 of the suitcase 10 by engaging the inlet port 24 with the injector outlet 32 of the delivery device 30. The delivery device 30, which may be a canister containing the pest-killing material (e.g., insecticide 34), is actuated to deliver the pest-killing material into the interior compartment 20. Insecticide 34 can be pressurized to above atmospheric pressure within the delivery device 30, such that the insecticide 34 is dispersed into interior compartment 20. Because the interior compartment 20 is effectively airtight, the concentration of insecticide 34 remains sufficiently high to kill the target pests and a majority of the injected insecticide 34 is not released prior to opening the suitcase 10. After a waiting period sufficient to kill the target pest, suitcase 10 may be opened and allowed to air. By eradicating pests without requiring the user to open the suitcase, the risk of accidental infestation can be greatly reduced, and, as a result, the user can be provided with great peace of mind.

Suitable pest-killing materials can include sulfuryl fluoride (available from DOW under the tradenames Vicane and Profume). Sulfuryl fluoride is colorless, odorless and leaves little or no residue. Sulfuryl fluoride is lethal to bed bugs (Cimex lectularius) in concentrations 3 times higher than that necessary to kill termites. While this high dosage can render sulfuryl fluoride a very expensive bed bug treatment when treating an entire dwelling, only a relatively small (and comparatively inexpensive) amount of the chemical may be needed to protect the same dwelling from bed bugs by treating only the suitcase 10 as a prophylactic. A typical 2,000 square foot home can require a volume of well over 20,000 cubic feet of insecticide to fill a fumigation bag. However, the average suitcase can have a volume of less than 3 cubic feet. Thus, the amount of insecticide used to prevent infestation can be greatly reduced by treating potentially infested luggage before pests are released into a dwelling. Likewise, the environmental burden is relatively inconsequential. Other chemicals may also be used.

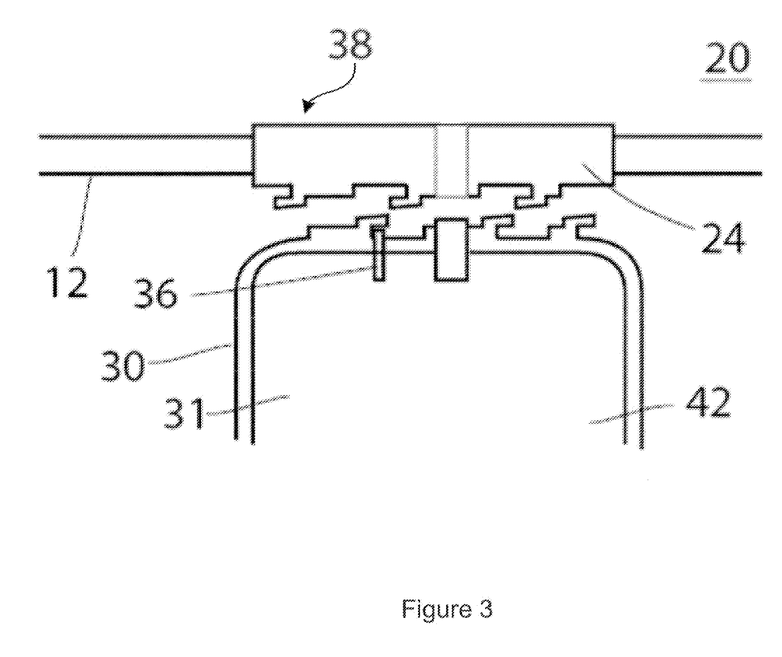

FIG. 2 shows a sectional view of delivery device 30 in the form of a canister 31 with an elongated outlet 32 and containing insecticide 34 or lethal non-insecticide gases 42. Elongated outlet 32 is inserted into an elastomeric gasket 26 of the inlet port 24. There are many other known ways to engage a pressurized delivery system with a receptacle. One other such example includes a mechanical lock 38 as in FIG. 3, shown to include a failsafe 36 designed to help ensure that the inlet port 24 is engaged with delivery device 30 before insecticide 34 or lethal non-insecticide gases 42 may be dispensed.

FIG. 4 shows a suitcase 10 in which lethal non-insecticide gases 42, such as carbon dioxide, may be introduced into an interior compartment 20 through an inlet port 24. An outlet port 44 is also provided at an opposite end of the suitcase 10 from the inlet port 24. The outlet port 44 acts as a release valve (e.g., a check valve), allowing the enclosed air (that will have higher concentrations of non-lethal gases 46 (such as oxygen and nitrogen) to be forced out as the lethal non-insecticide gas 42 is introduced. The outlet port 44 can be manually actuated or actuated by internal pressure within the suitcase 10 so that forcing pressurized lethal non-insecticide gas 42 into the inlet port 24 opens outlet port 44. Suitable release valves are described in U.S. Pat. No. 7,527,840, the contents of which are incorporated herein by reference. Alternatively or additionally, the outlet port 44 can include a selectively permeable membrane 45 to allow the enclosed air and non-lethal gases to be forced out as the lethal non-insecticide gas 42 is introduced. A hose 47 can be adapted to introduce lethal gases 42 into the inlet port 24. Lethal gas 42 would be allowed to remain long enough to reliably exterminate the pests of interest within the interior compartment before opening suitcase 10 for the first time after returning from a journey.

A number of embodiments of the invention have been described. Nevertheless, it will be understood that various modifications may be made without departing from the spirit and scope of the invention. For example, in some embodiments, extreme temperatures may be introduced into suitcase 10 by a flow of heated or cooled air 50. This thermally modified air 50 may be introduced through the inlet port 24 and outlet port 44 as described above, suitably enlarged to support a higher flow rate. Alternatively or additionally, a heating element 51 can be disposed within the interior compartment 20. The heating element 51 can be integrally manufactured within suitcase 10 (e.g., such that the suitcase itself is capable of being plugged into a power source) or detachably manufactured. The heating element 51 may be a ribbon wire such as kanthal (FeCrAl), nichrome or cupronickel (CuNi), or a thermal coefficient of resistance ceramics (such as barium titanate and lead titanate) which may act as its own thermistor 52. Alternately or additionally, a thermistor 52 or other such thermometer may be added for monitoring a temperature within the interior compartment 20. The thermistor 52 can be located at the center of the downward facing major side of the suitcase 10, as shown. In some cases, multiple thermistors 52 can be used for monitoring temperature within the interior compartment 20. If multiple thermistors 52 are used, the one measured to have the slowest response time can be used to determine temperature. In some cases, this measurement is reported to the user or associated display device 54, external to the suitcase. In some examples, a microprocessor 56 is integrated within the suitcase 10. The microprocessor 56 can be programmed to report when the combination of time and temperature internal to the suitcase 10 is sufficient to eradicate particular pests of interest, as more extreme temperatures are known to kill certain species faster, along known time/temp trajectories. Alternatively or additionally, a timer may be integrated into the suitcase 10 for this purpose.

Other embodiments are within the scope of the following claims.

What is claimed is:

1. A method for inhibiting pest infestation, the method comprising:
introducing a pest-killing material into an interior compartment of a closed piece of luggage, thereby exterminating pests residing within the interior compartment.

2. The method of claim 1, wherein the pest-killing material is a gas.

3. The method of claim 2, wherein the gas is an insecticide.

4. The method of claim 3, wherein the insecticide is sulfuryl fluoride.

5. The method of claim 3, wherein the insecticide is derived from Chrysanthemum.

6. The method of claim 2, wherein the gas is carbon dioxide.

7. The method of claim 1, further comprising heating the pest-killing material, wherein introducing the pest-killing material into the interior compartment of the closed piece of luggage comprises introducing the heated pest-killing material into the interior compartment of the closed piece of luggage.

8. The method of claim 1, further comprising cooling the pest-killing material, wherein introducing the pest-killing material into the interior compartment of the closed piece of luggage comprises introducing the cooled pest-killing material into the interior compartment of the closed piece of luggage.

9. The method of claim 1, wherein introducing the pest-killing material into the interior compartment of the closed piece of luggage comprises delivering the pest-killing material from a canister into the interior compartment of the closed piece of luggage.

10. The method of claim 1, wherein introducing the pest-killing material into the interior compartment of the closed piece of luggage comprises delivering the pest-killing material into the interior compartment of the closed piece of luggage via a hose.

11. The method of claim 1, wherein introducing the pest-killing material into the interior compartment of the closed piece of luggage comprises delivering the material through an inlet port in the luggage.

12. The method of claim 1, wherein the inlet port comprises an elastomeric gasket.

13. The method of claim 1, further comprising monitoring a temperature within the interior compartment of the closed piece of luggage.

14. The method of claim 1, further comprising utilizing one or more thermistors disposed within the interior compartment to monitor the temperature within the interior compartment.

15. The method of claim 1, further comprising calculating a waiting period corresponding to a period of time to wait, to allow the pest-killing material to kill pests residing within the interior compartment, before opening the piece of luggage.

16. The method of claim 15, wherein the waiting period is calculated based on a set of known parameters relating to at least one target pest.

17. The method of claim 15, further comprising utilizing a microprocessor to calculate the waiting period.

18. The method of claim 1, further comprising waiting a predetermined period of time, to allow the pest-killing material to kill pests residing within the interior compartment, before opening the closed piece of luggage,
wherein the predetermined period of time is calculated based on a set of known parameters relating to at least one target pest.

19. The method of claim 1, wherein the pests include bed bugs.

20. The method of claim 1, wherein the interior compartment has a volume of less than 6 cubic feet.

21. The method of claim 20, wherein the interior compartment has a volume of about 2 cubic feet to about 4 cubic feet.

22. The method of claim 21, wherein the interior compartment has a volume of about 3 cubic feet.

23. The method of claim 1, further comprising traveling from a first location to a second location with the luggage and without the pest-killing material.

24. The method of claim 23, further comprising storing the pest-killing material at the first location while traveling from the first location to the second location.

25. The method of claim 23, wherein the step of introducing the pest-killing material into the interior compartment of the closed piece of luggage is performed after returning to the first location from the second location.

26. The method of claim 1, wherein the interior compartment is substantially air tight.

27. The method of claim 1, wherein the pest killing material is heated air, and wherein introducing the pest-killing material comprises activating a heating element.

28. The method of claim 27, wherein the air is heated to a temperature of about 120° F. to about 150° F. over a time period of at least one hour.

29. The method claim 28, wherein the air is heated to a temperature of about 140° F. to about 150° F. over a time period of at least one hour.

30. The method of claim 28, wherein the air is heated to a temperature of about 120° F. over a time period of at least 24 hours.

31. A system for inhibiting pest infestation, the system comprising:
a personal effects transporting case that is closable to provide an interior compartment for storing personal effects; and
an input port arranged to accommodate introduction of a pest-killing material into the interior compartment.

32. The system of claim 31, wherein the input port is arranged between an outer surface of the personal effects transporting case and the interior compartment.

33. The system of claim 32, wherein the inlet port comprises an elastomeric gasket.

34. The system of claim 31, wherein the interior compartment is capable of retaining gas or vapor.

35. The system of claim 31, further comprising a delivery device containing a pest-killing material, wherein the delivery device includes an outlet capable of cooperating with the input port for introducing the pest-killing material into the interior compartment.

36. The system of claim 35, wherein the pest-killing material is a gas.

37. The system of claim 36, wherein the gas is an insecticide.

38. The system of claim 37, wherein the insecticide is sulfuryl fluoride.

39. The system of claim 37, wherein the insecticide is derived from chrysanthemum.

40. The system of claim 36, wherein the gas is carbon dioxide.

41. The system of claim 31, further comprising a temperature measurement device arranged to measure a temperature within the interior compartment.

42. The system of claim 41, further comprising a display device configured to display a temperature measured by the temperature measurement device.

43. The system of claim 31, wherein the personal effects transporting case comprises a microprocessor configured to calculate a waiting period corresponding to a period of time to wait, to allow the pest-killing material to kill pests residing within the interior compartment, before opening the personal effects transporting case.

44. The system of claim 43, wherein the microprocessor is configured to calculate the waiting period based on a set of known parameters relating to at least one target pest.

45. The system of claim 31, wherein the interior compartment has a volume of less than 6 cubic feet.

46. The system of claim 45, wherein the interior compartment has a volume of about 2 cubic feet to about 4 cubic feet.

47. The system of claim 46, wherein the interior compartment has a volume of about 3 cubic feet.

48. The system of claim 31, wherein the interior compartment is substantially air tight.

49. A system for inhibiting pest infestation, the system comprising:
a personal effects transporting case that is closable to provide a interior compartment for storing personal effects; and
a heating element.

50. The system of claim 49, wherein the heating element is integrally manufactured within the personal effects transporting case.

51. The system of claim 49, wherein the heating element is adapted to reside within the interior compartment and is removable from the personal effects transporting case.

52. The system of claim 49, further comprising one or more thermistors disposed within the interior compartment to monitor the temperature within the interior compartment.

53. The system of claim 49, wherein the interior compartment is substantially air tight.

54. A method comprising:
heating air in an interior compartment of a closed piece of luggage, thereby exterminating pests residing within the interior compartment.
